(19) United States
(12) Patent Application Publication
(10) Pub. No.: US 2008/0104501 A1
(43) Pub. Date: May 1, 2008

(54) Cross-tier intelligent document generation and management

(75) Inventors: Juergen Sattler, Wiesloch (DE); Hilmar Demant, Karisdorf (DE); Joachim Gaffga, Wiesloch (DE)

Correspondence Address: SCHWEGMAN, LUNDBERG & WOESSNER/SAP, P.O. BOX 2938, MINNEAPOLIS, MN, 55402, US

(73) Assignee: SAP AG

(21) Appl. No.: 11/588,680

(22) Filed: Oct. 27, 2006

(51) Int. Cl. G06F 17/00; G06Q 10/00

(52) U.S. Cl. 715/224; 715/255; 705/1

(57) ABSTRACT

This application relates to document generation and management and, more particularly, cross-tier intelligent document generation and management. Various embodiments provide systems, methods, and software to quickly generate document templates with fields associated with data items, instantiate documents from such document templates, and submit the documents for processing and dispatch to intended recipients.

### TECHNICAL FIELD

This application relates to document generation and management and, more particularly, cross-tier intelligent document generation and management.

### BACKGROUND INFORMATION

Documents generated within organizations, large and small, commonly involves a finite number of documents that are created many times. Some such documents include invoices, order and shipping related documents, service documents, and general correspondence. Such documents often include data stored by the organization, such as in a database.

Common mail-merge type applications allow for a single document definition to be used and populated with data multiple times based on data stored in a database in view of retrieval arguments associated with document definition fields. However, these documents must then be manually handled and manually dispatched. This involves considerable additional effort. Further, the efficiency benefits of using a mail-merge to complete a particular task are generally only realized when a large number of documents are created.

Generating a single document with data from an organizational data store in an efficient manner commonly involves great programming efforts. Each document to be created needs to be programmed as a report in an application and then printed or electronically dispatched. However, these report-type documents are generally inflexible and cannot be edited.

Additionally, correspondence management applications are commonly used to catalog and track documents generated and dispatched by an organization. These previous efforts do not integrate well with such correspondence management applications. Correspondence management application integration usually involves additional programming to integrate programmed document generation code and mail-merge applications.

### BRIEF DESCRIPTION OF THE DRAWINGS

FIG. 1 is a schematic illustration of a system according to an example embodiment.

FIG. 2 is a schematic illustration of a system according to an example embodiment.

FIG. 3 is a schematic illustration of a system according to an example embodiment.

FIG. 4A and FIG. 4B illustrate user interfaces according to example embodiments.

FIG. 5A-FIG. 5E illustrate user interfaces according to example embodiments.

FIG. 6 is a block diagram of a method according to an example embodiment.

FIG. 7 is a block diagram of a method according to an example embodiment.

### DETAILED DESCRIPTION

The present subject matter provides several embodiments that provide systems, methods, and software that allow flexible document generation and editing in small and large quantities. Some such embodiments easily integrate with correspondence management systems, enterprise resource planning (ERP) applications, disparate data stores, and other system and application elements.

In some embodiments, document templates can be generated and stored for later use in document generation. Some embodiments provide a series of user interfaces that facilitate template generation by providing data field views from which data and text fields can be selected for inclusion in a document template. Selected data and text fields can be ordered in such user interfaces and the document template associated with one or more entities defined within an organization's entity data.

Further embodiments provide mechanisms from which to generate documents as a function of a document template, a selected entity, and retrieved data. Such documents can then be processed, either by a client or by an application platform, dispatched, and logged by a correspondence management system. These embodiments and others are described below.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software, or a combination of software and hardware in one embodiment. The software comprises computer executable instructions stored on computer readable media such as memory or other type of storage devices. The term “computer readable media” is also used to represent carrier waves and electromagnetic signals on which the software is transmitted. Further, such functions correspond to modules, which are software, hardware, firmware, or any combination thereof. Multiple functions are performed in one or more modules as desired, and the embodiments described are merely examples. The software may be executed on one or more of a digital signal processor, application specific integrated circuit, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

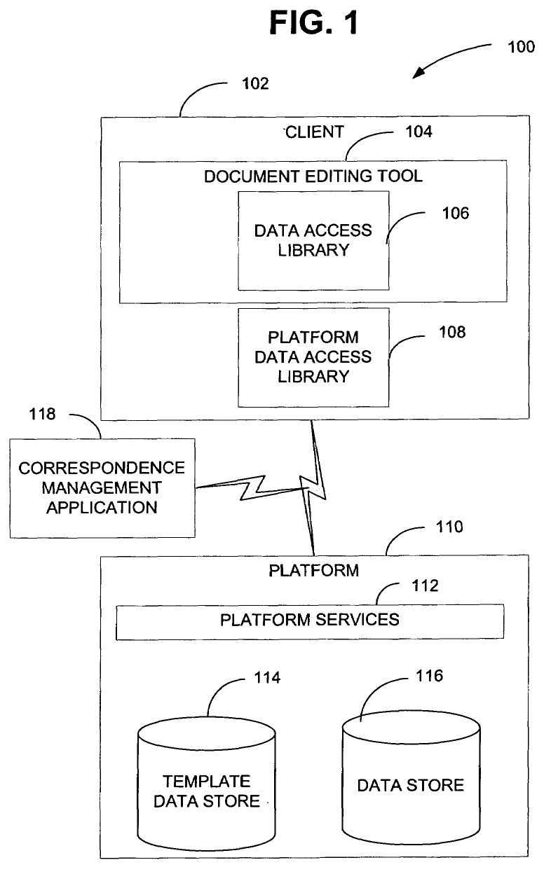

FIG. 1 is a schematic illustration of a system 100 according to an example embodiment. The example system 100 includes a client 102, a platform 110, and a correspondence management application 118.

In some embodiments, the client 102 is a personal computer, such as a desktop computer, laptop computer, mobile computing device, or other physical or virtual or emulated computing device or client. The client 102 includes a document editing tool 104. The document editing tool 104, in some embodiments, is a word processing program such as Microsoft® Office Word. The document editing tool 104 may include a data access library 106, such as a Dynamic Link Library (“DLL”). This DLL, in some embodiments, provides data access services to documents and document templates to integrate data from a data source, such as a database, into such documents and document templates. The DLL, in some embodiments, is configurable. In some embodiments, the DLL is configurable through the document editing tool 104 or through client 102 settings associated with a document or document template open within the document editing tool 104.

The client 102, in some embodiments, further includes a platform data access library 108, such as a DLL. The platform data access library 108, in some embodiments, augments services available within the document editing tool 104 via the data access library 106. Some such services allow the document editing tool 104 to leverage services available from one or more other applications, such as a correspondence management application 118, a platform 110 application, or platform 110 services 112. In some such embodiments, the platform 110 services 112 include document template services 114 that provide searchable document templates from a template data store 114 to the document editing tool 104. Other platform 110 services 112 include data services that leverage data stored in a platform 110 data store 116.

The platform 110, in some embodiments, is a platform application, such as a platform layer of an enterprise resource planning (“ERP”) application platform. The platform 110, in some embodiments, includes platform 110 services 112, a template data store 114, and one or more other data stores 116. The platform 110 services 112 provide functionality to processes that execute within the platform 110 and outside of the platform 110, such as to the platform data access library 108 and to the correspondence management application 118. In some embodiments, the architecture of the platform is a service-oriented architecture. The platform services 112 may be provided via one or more objects that access and process data when called. Some such platform services 112 receive input and provide output.

The template data store 114 is a storage location for document templates. The template data store 114, upon a request originating with the document editing tool 104 and received through the platform services 112, provides a document template to the document editing tool 104. In some embodiments, a document template request is received by one or more of the platform services 112 with an association to an entity represented in one or more of the other platform 110 data stores 116. In such an instance, the platform services 112 retrieve the requested document template from the document template data store 114 and retrieve data associated with the retrieved document template in view of the associated entity of the request. The retrieved data is then populated into the document template and the data populated document template is sent back to the document editing tool 104 which instantiates the document template as a document, which may then be edited. In some other embodiments, the document template and entity representation are received in separate requests from the document editing tool. In such embodiments, the document editing tool populates the data into the instantiated document template.

As mentioned above, the data access library 106 of the document editing tool 104 provides data access services. In some embodiments, the data access library 106 is a Microsoft® Word DLL providing Smart Document functionality to Microsoft® Word. Smart Documents is a technology available in some Microsoft® Office applications. Smart Documents technology allows a user to select document options programmed into a smart document. A smart document may also automatically retrieve data from a database to use in a document generated from a smart document template. However, smart document templates must be stored locally on the client to be instantiated. The platform data access library 108 provides an avenue to allow a user to select a document template stored on the platform 110 within the document template data store 114. This removes the need to store many document templates on the client 102 and simplifies document template updating. Further, configuring the client becomes much easier because the document editing tool 104 data access library 106 only needs to be configured to communicate with the platform data access library 108. The platform data access library 108 then communicates with the platform 110 services 112 to gain access to the wealth of services available on the platform 110.

The platform data access library 108 is located on the client 102. In other embodiments, the platform data access library 108 is located on the platform 110 or other location available to the client 102. In some embodiments, the platform data access library communicates with the platform services over a network. The network may include one or more of a local area network (“LAN”), a wide area network (“WAN”), a value added network (“VAN”), a global network, such as the Internet, or other network type depending on the particular embodiment. In some embodiments, the correspondence management application 118 is also coupled to the network.

Communication between the platform data access library 108, the platform services 112, and the correspondence management application 118 may be encoded in a markup-language, such as extensible Markup Language (“XML”). In other embodiments, the communication is encoded by the sender according to a standard that is understood by the recipient.

In some embodiments, as stated above, the platform 110 is at least a portion of an enterprise resource planning application, such as an ERP system available from SAP, AG of Waldorf, Germany. In some such embodiments, the correspondence management application 118 is an integrated portion of the ERP system. In other embodiments, the correspondence management application is an application commonly available from any of a number of developers in the correspondence management area of the software industry.

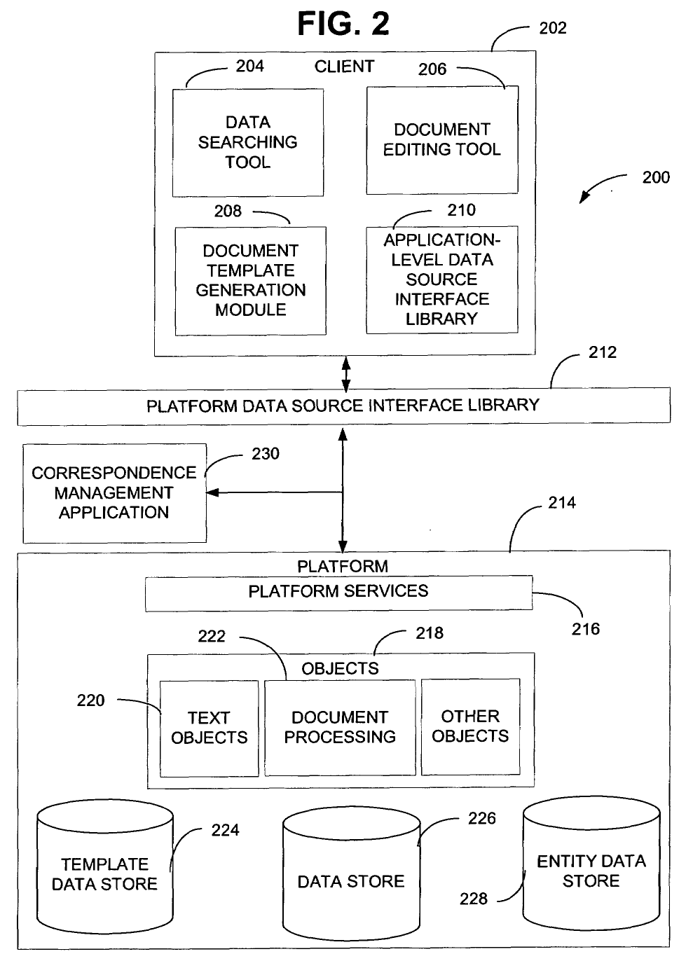

FIG. 2 is a schematic illustration of a system 200 according to an example embodiment. The example system 200 includes a client 202, a platform 214, and a correspondence management application 230.

The client 202 includes a data searching tool 204, a document editing tool 206, a document template generation module 208, and an application-level data source interface library 210.

The application-level data source interface library 210 provides data access services to the document editing tool 206. The application-level data source interface library 210 generally is available from a developer of the document editing tool 206. The application-level data source interface library 210 evaluates a document template to identify data needed by the document template and causes the data to be retrieved directly from a location where the needed data is stored. In the system 200, the application-level data source interface library 210 is configured to direct all data access requests to a platform data source interface library 212.

The platform data source interface library 212, in some embodiments, is located on the client 202. However, the platform data source interface library 212 may be located elsewhere so long as the application-level data source interface library 210 may access it. In some embodiments, the platform data source interface library 212 is a DLL. In some embodiments, the platform data source interface library 212 receives data access requests from the application-level data source interface library, determines a proper platform service to call to service the data request, and makes the determined platform service call. Upon receipt of a return message from the called platform service, the received message is then appropriately processed by the platform data source interface library 212, and if needed, forwarded back to the application-level data source interface library 210 of the document editing tool 206.

The platform data source interface library 212, in some embodiments, is also utilized by the data searching tool 204. In some such embodiments, the data searching tool 204 provides one or more user interfaces that may be used to query data stored with the platform 214. In some such embodiments, one of the user interfaces allows searching for and selection of an entity, such as a customer, represented within a data store of the platform. The same, or another user interface, may also identify and allow selection of a document template associated with the entity. For example, a user may use a first user interface to identify a group of customers. The user then selects a customer and the same or another user interface displays a list of document templates associated with the selected customer. One or more of the listed document templates may then be selected for instantiation within the document editing tool 206. In some embodiments, upon selection of a document template, a document template request is sent to the application-level data source interface library 210 which then retrieves the selected document template and any data identified in the document template that is associated with the selected entity.

After a document template is instantiated within the document editing tool 206, a user may then modify the instantiated document. This may include selecting from two or more optional text snippets as included with the document template. For example, a document template may provide for selection of one of two text snippets. The first snippet may provide language such as, “Thank you for your quotation request. This quotation is good for thirty-days.” The second text snippet may provide language such as, “Thank you for your quotation request. This quotation is good for fifteen days.” Modification of the instantiated document may also include adding custom, or document specific text, modification of data populated into the template, entering a quantity of items ordered on an invoice document, or other text or data modifications.

The document editing tool 206 may also allow insertion of text additional text snippets that were not part of the original document template from which a document was instantiated. Some such text snippets may include data field mappings that cause data to be populated into a text snippet. Also, the document editing tool may allow insertion of data fields. In some such embodiments including one or more of insertable data fields and text snippets including data fields, the data to be inserted must be already available within the instantiated template. In other embodiments, the data may be retrieved when the data is inserted.

After the instantiated document is completed, at least two actions may be taken. One action is that the instantiated document template, if modified with additional text or inserted data fields or text snippets, may be saved as an extended document template. The second action is that the document may be submitted for processing. The processing, in some embodiments, is performed on the client 202. In other embodiments, the document is submitted to the platform 214 via the platform data source interface library 212 for processing. In other embodiments, the document is submitted to the correspondence management system 230 for processing.

The processing of the document on the client 202 may include printing the document for dispatch, attaching the document to an email for dispatch, putting the text of the document into the text of an email or Simple Messaging Service (“SMS”) message, or placing the document into another form for dispatch. In some embodiments, attaching the document to an email for dispatch includes attaching the document as a PDF file, a word processing file, a TIFF image, or other suitable file type depending on the embodiment. When the document is successfully processed, a message is generated on the client 202 and sent to the correspondence management application 230. The message sent to the correspondence management application 230, in some embodiments, include one or more of identifying the action taken, a copy of the document, the data and text of the document in a text form, and the date and time the document was processed and/or dispatched. The correspondence management application 230 may then log the correspondence processed and/or dispatched.

The processing of the document on the platform 214 may include transmitting a copy of the document to the platform 214 for processing. In other embodiments, the document editing tool may only transmit a template identifier and the text and data of the document to be processed. A document processing object 222 may then processes the document by retrieving the identified document template, if necessary, and populating the template with the received data and text. In either case, the document is then rendered. After rendering, the document processing object 222 may then do one or more of attaching the rendered document to a batch print job for processing by a bulk printing and mailing system, fax the document, print the document for mailing, attach the document to an email, email the content of the rendered document, place the text of the document in an SMS message, or otherwise dispatch the document as necessary. The document processing object 222 then sends a message to the correspondence management system, similarly to the client document processing, to cause the document to be logged.

The processing of the document by the correspondence management system 230 may include submitting the document template, data, and text to the correspondence management system 230, which then renders and transmits the document. The processing by the correspondence management system 230 may also include submitting an image of the document, or a word processing document, to the correspondence management system 230, which then renders and transmits the document. In both instances, the correspondence management system 230 logs the correspondence according to the rules, processes, and procedures defined within the system.

Some embodiments of the system 200 also include a document template generation module 208 within the client 202. The document template generation module 208 provides a set of tools that can be used to generate a document template and store the document template in the platform 214. The document template generation module 208 interacts with the platform 214 via the platform data source interface library 212.

In some embodiments, the document template generation module 208, when used to generate a document template, allows a user to select a document template type from document template types that already exist in the platform 214. A new document template type may also be defined. A document template type, in some embodiments, causes one or more document portions to be included. For example, if a selected document template type is “invoice,” certain document portions will be included. These document portions may include customer address fields and an item description/quantity/price/total table. Thus, selection of a document template type makes certain fields available in the document template.

A selection of data sources and fields is also available for selection via the document template generation module 208. This allows selection of data sources and items and association of the selected sources with document template fields, such as address fields with portions of customer address fields added to an invoice document template type. Some embodiments also allow selection of standard text fields, optional text fields, and addition of custom text fields to a document template. Further, the document template generation module 208 allows organizing of the selected data source fields and added text within the document template, such as specification of an order of which the selected document template portions will be rendered. The document template generation module 208 may then be utilized to store the document template in a document template data store 224 of the platform 214 via the platform services 216.

The platform 214 of the system 200 includes the platform services 216, objects 218, a document template data store 224, an entity data store 226, and one or more other data stores 228. The platform services 216 make services of the objects 218 available to the platform data source interface library 212. The objects 218 include one or more text objects 220 that provide text functionality to document templates stored in the document template data store 224 and may be instantiated in the document editing tool 206 and the document template generation module 208. Some such text objects provide selectable text snippets, standard document text, text tables, and other text structures that may be linked to data fields in one or more data sources.

The objects may also include a document processing object 222. The document processing object 222 may alternatively be located on the client 202. In either circumstance, the document processing object 222 processes a document to prepare the document for dispatch, routes the document for dispatch via one or more of a conventional or electronic mode, and sends a message to the correspondence management application 230 to cause the document to be logged.

The document template data store 224 holds document templates from which documents may be instantiated in the document editing tool 206 and rendered from by the document processing object 222. The entity data store 226 includes data defining entities within the system 200. An entity is generally a person or organization, such as a customer, supplier, business partner, or other entity. In some embodiments, one or more document templates may be associated with one or more entities. Thus, when a user goes about instantiating a document from a document template, the user may search by entity to identify a proper document template from which to instantiate the document.

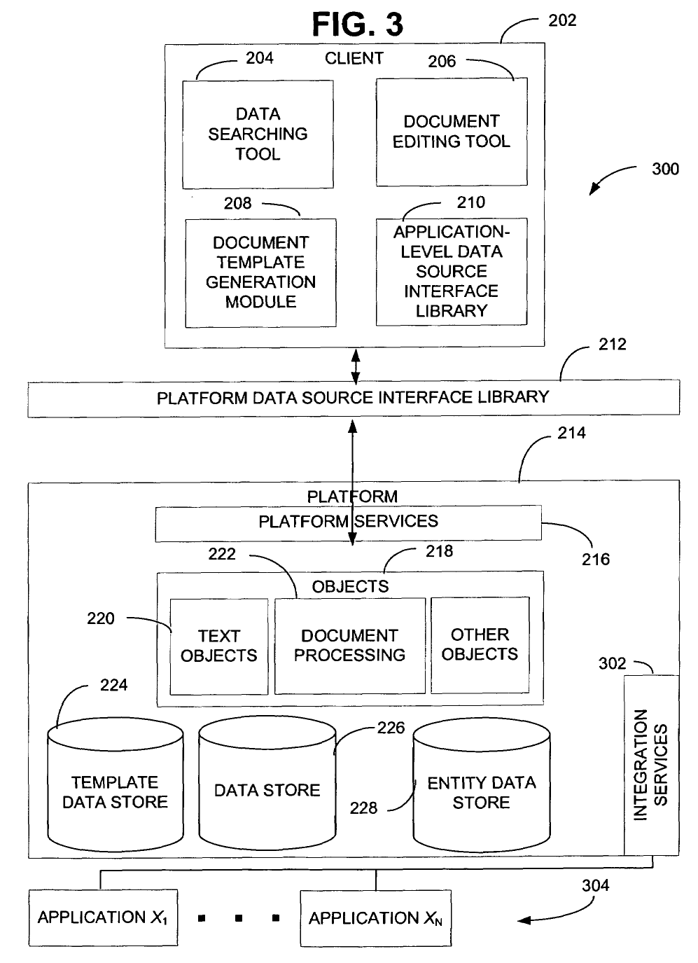

FIG. 3 is a schematic illustration of a system 300 according to an example embodiment. The system 300 includes the client 202 and the platform data source interface library 212 as described above with regard to the system 200 of FIG. 2. The system 300 further includes the platform 214 as described above with regard to the system 200, but also includes integration services 302. The integration services 302 are services that integrate operation of the platform 214 with operations of other applications 304, data sources, computing environment, or other similar data processing environments. This integration can be made over a network such as a local area network, system area network, wide area network, the Internet, a value added network, or other network type.

In some embodiments, the integration services 302, as well as some or all of the other services described herein, may be services available within an object. Such objects may allow access to their services in whole or in part to other objects within the platform 214. In some embodiments, access to some services of the platform 214 are restricted from access from outside of the platform 214. Thus, in such embodiments, access to such services restricted from outside access may still be made, but such access is made indirectly through the platform services 216 or through the integration services 302.

In some embodiments, the other applications 304 may include virtually any application type. Some example other applications 304 include data base applications, enterprise resource planning (“ERP”) applications, proprietary applications, customer relationship management (“CRM”) applications, and others.

The integration services 302 allow the other applications 304 to operate in a synergistic manner with one or more applications of the platform 214. The synergistic operation of such applications may allow movement of data back and forth between the platform 214 and the other applications 304 for various purposes, such as data synchronization.

The architecture of the system 300 provides further benefits. For example, document templates stored within the template data store 224 may include references to data within one or more of the other applications, Thus, when such a document template is instantiated within the document editing tool 206, referenced data from the one or more other applications is retrieved and available within the instantiated document. Further, document templates may be generated using the document template generation module 208 that include references to data of the one or more other applications.

In the system 300 embodiment, and others, the platform data source interface library 212 leverages the integration services 302 of the platform 214 to integrate the platform and other applications 304 with the common interface of the document editing tool 206 users are familiar with. This simplifies document generation for users and speeds the process of document generation when the documents need data from the platform 214 or the other applications 304.

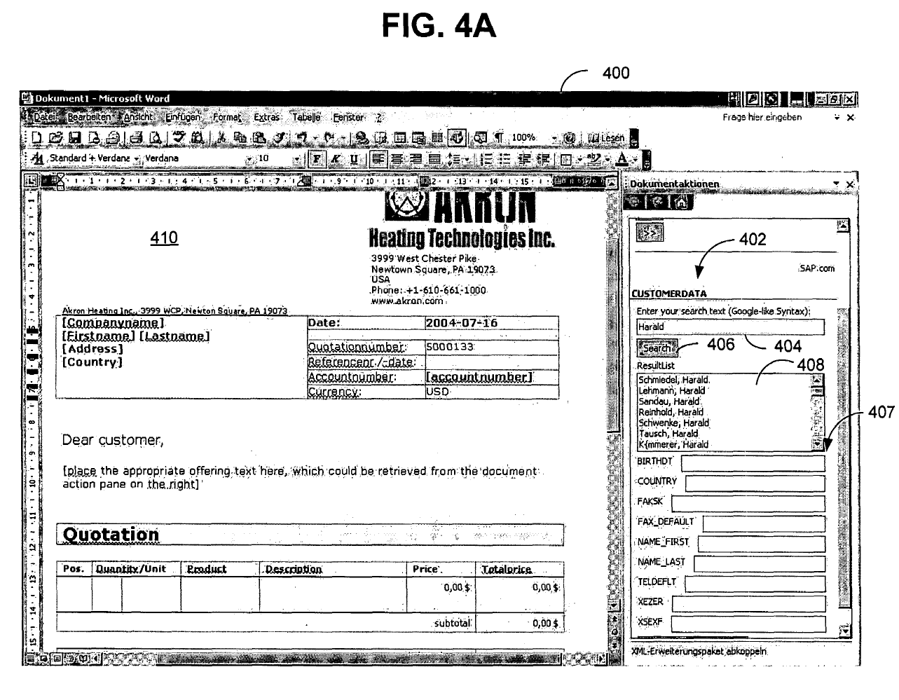

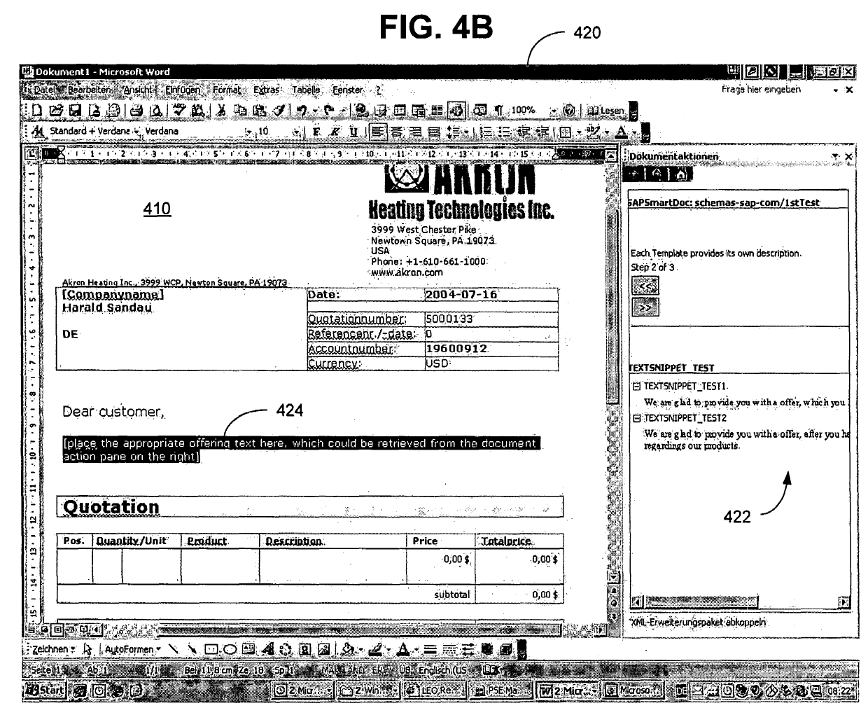

FIG. 4A illustrates a user interface 400 according to an example embodiment. The user interface 400 includes a data search portion 402 and a template instantiation portion 410. This specific illustration of the user interface 400 is of a quotation document template already selected for instantiation in the template instantiation portion 410. Thus, the task to be accomplished in the data search portion 402 is to search for and identify information to be populated into the instantiated document template in the template instantiation portion 410.

To search for the data, text is entered into the text box 404 and the search button 406 is selected. In some embodiments, a user may enter any text to search upon and a search engine will process the search request to identify any potentially relevant data. Alternatively, a user could enter a structured query. The data searched for is the data the instantiated template needs. Thus, in some embodiments, when a template is instantiated in the template instantiation portion 410, the user interface 400 evaluates the template definition to identify the needed data. The fields of needed data are then displayed in a area 407 of the data search portion 402.

After a search is performed, the search results are displayed in the area 407. The user may then select one of the search results. When a search result is selected, the data is populated into the instantiated document template. The instantiated document may then be manipulated to conform the instantiated document to the needs of the user. In some embodiments, the instantiated document template may include optional text snippets for one or more portions of the instantiated document. An example is provided in FIG. 4B.

FIG. 4B illustrates a user interface 420 according to an example embodiment. The user interface 420 includes a document action pane 422 and the template instantiation portion 410. The illustrated document action pane 422 includes two text snippets which may be moved to the instantiated document in the template instantiation portion 410 via a drag-and-drop action, a copy and paste action, a double-click of a mouse, or other similar actions to move the text to the highlighted portion 424. In some embodiments, only one of the two text snippets may be moved to the instantiated document. In other embodiments, two or more text snippets may be moved. In yet further embodiments, a text snippet need not be moved to the instantiated document. Alternatively, a user may choose to manually edit the highlighted text.

After an instantiated document has been edited, the document may be submitted for processing. As described above, this processing may occur on either the client or on the platform.

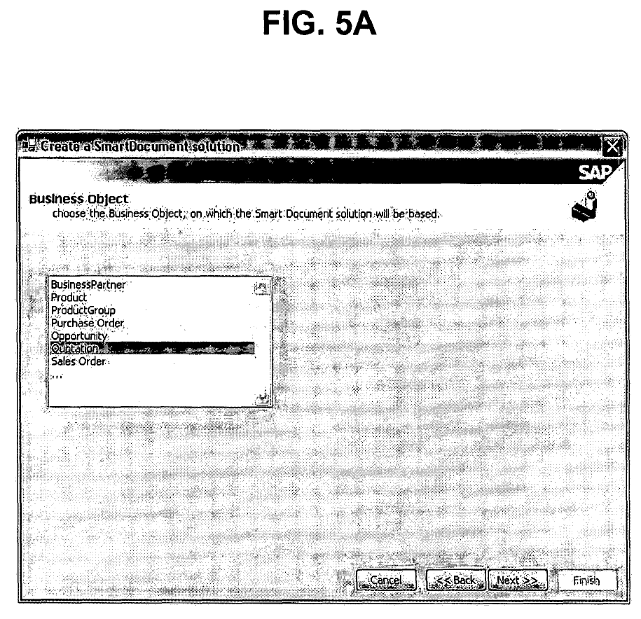

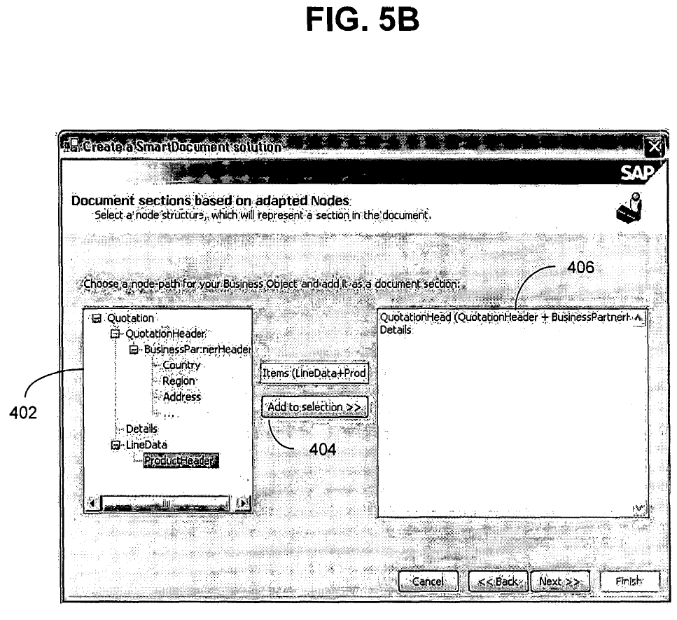

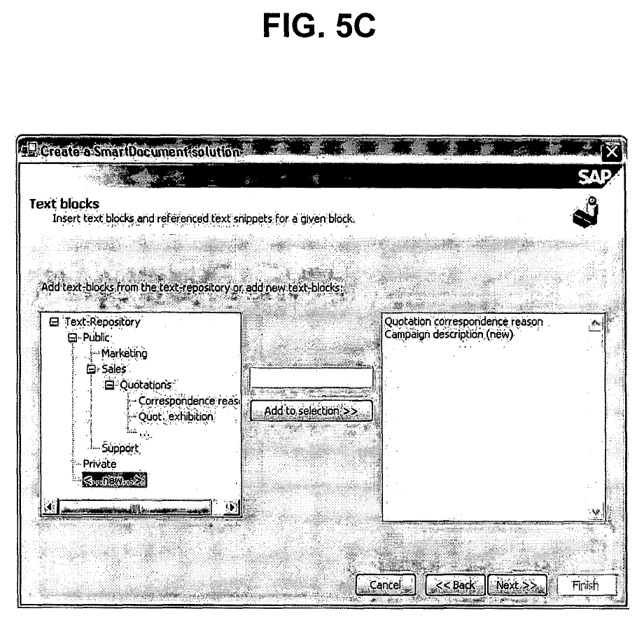

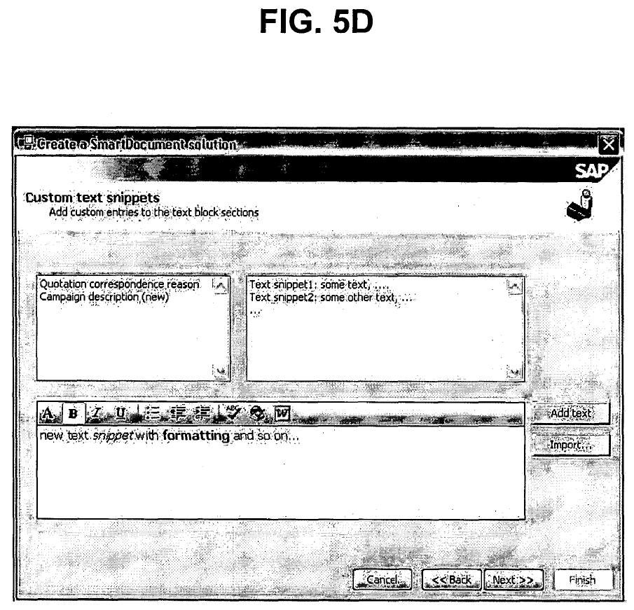

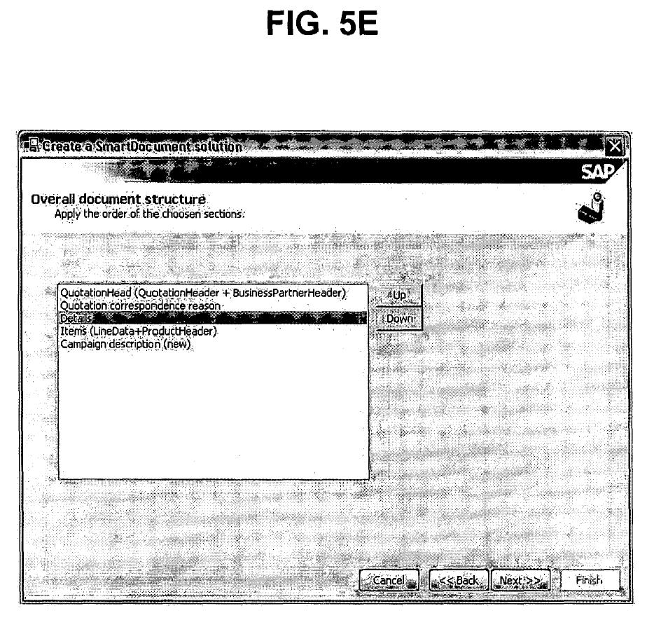

FIG. 5A-FIG. 5E illustrate user interfaces according to example embodiments. These user interfaces are presented in a series to a user when defining a new document template. The user interface of FIG. 5A allows the user to select a type of document template to generate. However, as can be seen from this user interface, a user may also select an application object, such as a platform object described above with regard to FIG. 2 to generate a document template from. Once selected, a user then selects one of the action buttons on the bottom of the user interface, such as the next button.

The user interface of FIG. 5B allows a user to select document portions, or sections, to include in the document template. Available document sections are displayed on the left side 502 of the user interface and selected document section are displayed on the right side 506 of the user interface. To select an available document section, a user may use the selection button 504 when an available section is selected on the left side 502. Alternatively, a user may double click and available section or drag an available section from the left side 502 to the right side 504 utilizing drag-and-drop functionality. In some embodiments, the available document sections are made available as a function of the document type selection made utilizing the user interface of FIG. 5A. After the desired document selections are made, a user may then select an action button, such as the next button.

FIG. 5C provides a user interface allowing a user to specify text blocks to include in the document template. Text blocks can be selected for inclusion in a similar manner as the document portions of FIG. 5B.

FIG. 5D provides a user interface allowing a user to define optional text snippets that may be selected from when the document template is generated and instantiated within the document editing tool.

FIG. 5E provides a user interface that can be used to modify the order of the document sections.

After the document template properties have been defined, such as through the use of the user interfaces of FIG. 5A-FIG. 5E, the user may click a finish button and the document template will be generated. The properties defined by the user will be included in the document template. The document template will be stored in a document template data store, such as within the platform as described above. In some embodiments, the document template is stored in an XML representation.

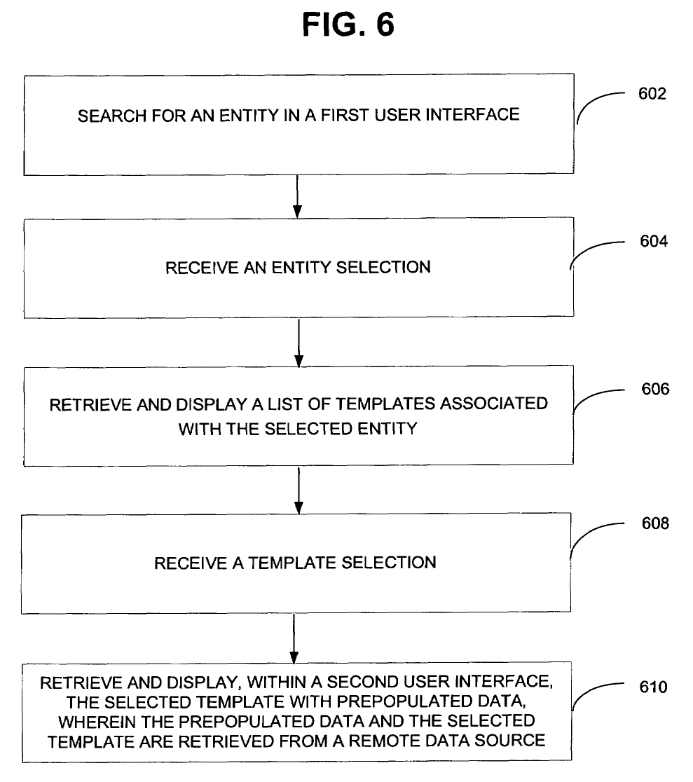

FIG. 6 is a block diagram of a method 600 according to an example embodiment. The example method includes searching for an entity in a first user interface 602, receiving an entity selection 604, and retrieving and displaying a list of templates associated with the selected entity 606. The method may further include receiving a template selection 608 and retrieving and displaying, within a second user interface, the selected template with prepopulated data, wherein the prepopulated data and the selected template are retrieved from a remote data source 610. In some embodiments the remote data source is accessed by a client module logically operative between components of the first user interface and the remote data source. The client module typically includes a configurable mapping of possible data access actions to one or more services of the remote data source. In some embodiments, the remote data source includes one or more databases accessible over a network. The network may include one or more of a wireless or wired LAN, WAN, Internet connection, or a connection to one or more other network types.

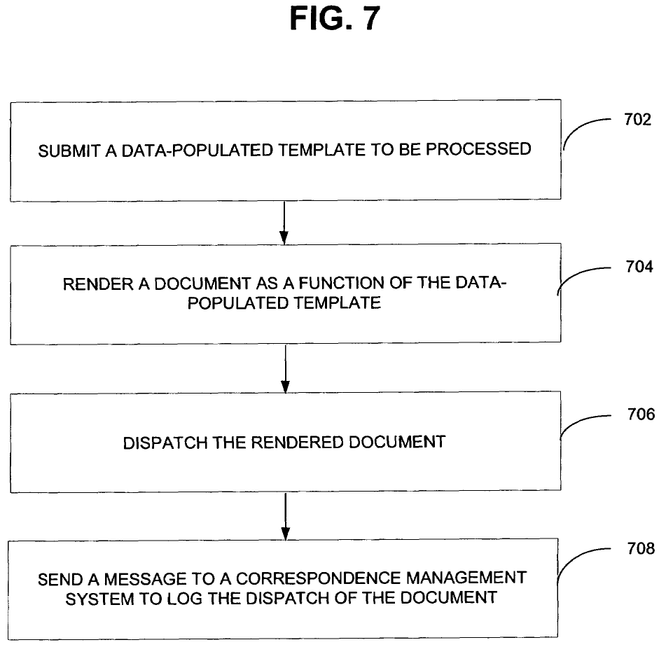

FIG. 7 is a block diagram of a method 700 according to an example embodiment. The example method includes submitting a data-populated template to be processed 702 and rendering a document as a function of the data-populated template 704. The method 700 may further include dispatching the rendered document 706 to an intended recipient and sending a message to a correspondence management system to log the dispatching of the document 708.

In some embodiments, submitting the data-populated template 702 includes transmitting a template identifier and transmitting the data of the data-populated template. In such embodiments, each data item is associated with a template field within which each data item is populated to. Further, dispatching the rendered document commonly includes generating an email message and populating an email address field of the email message with an email address included in the data to be processed. The rendered document may then be attached to the generated email message and the email may be sent. In some embodiments, the data populated template may be submitted to the correspondence management system and the correspondence management system will render and dispatch the rendered document.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A method comprising:
submitting a data-populated template to be processed;
rendering a document as a function of the data-populated template;
dispatching the rendered document; and
sending a message to a correspondence management system to log the dispatching of the document.

2. The method of claim 1, wherein the data-populated template is submitted for processing by a client to an application platform to cause the application platform to:
perform the rendering and dispatching of the document; and
the sending of the message to the correspondence management system.

3. The method of claim 1, wherein a client performs the rendering and dispatching of the document and the sending of the message to the correspondence management system.

4. The method of claim 1, wherein:
rendering the document includes placing the text of the document in an SMS message; and
dispatching the rendered document includes sending the SMS message.

5. The method of claim 1, wherein submitting the data-populated template includes:
transmitting a template identifier; and
transmitting the data of the data-populated template, wherein each data item is associated with a template field within which each data item is populated to.

6. The method of claim 1, wherein dispatching the rendered document includes:
generating an email message and populating an email address field of the email message with an email address included in the data to be processed;
attaching the rendered document to the generated email message; and
sending the email message.

7. The method of claim 1, wherein:
the data populated template is submitted to the correspondence management system; and
submitting the data populated template to the correspondence management system causes to the correspondence management system to render and dispatch the document.

8. A system comprising:
a data searching tool;
a document editing tool;
an application-level data source interface library providing data access services to the data search tool and the document editing tool; and
a platform-level data source interface library including platform-level data access services, wherein the application-level data source interface library data access services are mapped to the platform-level data access services.

9. The system of claim 8, wherein the platform-level data source interface library is a Dynamic Link Library (DLL).

10. The system of claim 8, wherein the platform-level data source interface library includes methods to access services of one or more objects of an application platform.

11. The system of claim 8, wherein the data search tool provides searching functionality to allow searching for and selection of an entity to receive a document.

12. The system of claim 8, wherein the data search tool provides searching functionality to allow searching for and selection of a document template from which to generate a document.

13. A system comprising:
a platform level including:
an entity data store;
a document template data store, wherein a document template stored in the document template data store is associated with one or more entities stored in the entity data store; and
a platform-level data store interface library including platform-level data access services; and
an application level operative to generate a document as a function of a document template stored in the document template data store, wherein the application level includes an application-level data interface library including data access services mapped to platform-level data access services.

14. The system of claim 13, wherein the application level includes a data search tool providing data searching and selection functionality to allow searching of data stored in the entity data store and the document template data store and selection of an entity and a document template from which to generate a document.

15. The system of claim 13, wherein a document template includes an association to data accessible by the platform level.

16. The system of claim 15, wherein the document template, when instantiated within the application level, causes the application-level data interface library to retrieve data as a function of the document template association to data by calling one or more of the platform-level data store interface library data access services and populate the retrieved data into the instantiated document template.

17. A system comprising:
a document editing application;
a platform application, wherein the platform application includes stored document templates and data;
a correspondence management application;
wherein the document editing application:
generates a document for editing as a function of document templates and data retrieved from the platform application, and
submits generated and edited documents to the platform application for processing; and
wherein the platform application renders and dispatches a document submitted from the document editing application and sends a message to the correspondence management application to log the document.

18. The system of claim 17, wherein the platform application and the correspondence management application are components of an enterprise resource planning (ERP) application suite.

19. The system of claim 17, wherein the document editing application is Microsoft Word.

20. The system of claim 17, wherein the document editing application includes a platform application specific module to provide data access services between the document editing application and the correspondence management system.

21. The system of claim 17, wherein the document editing application includes a document template search and selection interface to allow searching and selection of document templates associated with an entity.

22. A system comprising:
a platform application including data sources and a document template data store;
a document template generation module including a series of user interfaces to guide a user through generation of a document template, wherein the series of user interfaces allow a user to:
select a document template type,
view available data sources and select fields from the data sources to include in the document template,
add standard and custom text to the document template,
organize the selected data source fields and added text within the document template, and
store the document template in the document template data store;
a document editing application capable of instantiating a document template from the document template data store, wherein a document template, when instantiated, is populated with data associated with the document template.

23. The system of claim 22, wherein the data sources include one or more objects.

24. The system of claim 22, wherein the document template generation module's series of user interfaces further includes a user interface through which to receive text translation of text added to a document template.

25. A machine-readable medium, with encoded instruction, which when executed, cause a machine to:
submit a data-populated template to be processed;
render a document as a function of the data-populated template;
dispatch the rendered document; and
send a message to a correspondence management system to log the dispatching of the document.

26. The machine-readable medium of claim 25, wherein submitting the data-populated template includes:
transmit a template identifier; and
transmit the data of the data-populated template, wherein each data item is associated with a template field within which each data item is populated to.

27. The machine-readable medium of claim 25, wherein dispatching the rendered document includes:
generate an email message and populating an email address field of the email message with an email address included in the data to be processed;
attach the rendered document to the generated email message; and
send the email message.

28. The machine-readable medium of claim 25, wherein:
the data populated template is submitted to the correspondence management system;
the correspondence management systems renders and dispatches the rendered document.

29. A system comprising:
a document editing application;
a platform application, wherein the platform application includes stored document templates, data, and integration services to interface with one or more other applications, wherein the document editing application inserts data retrieved from at least one or more of the other applications via the integration services of the application platform into a document.
